(19) United States
(12) Patent Application Publication
(10) Pub. No.: US 2010/0082655 A1
(43) Pub. Date: Apr. 1, 2010

(54) PARALLEL EXECUTION OF RANGE QUERY

(75) Inventors: Adam SILBERSTEIN, San Jose, CA (US); Brian Frank Cooper, San Jose, CA (US); Yimir Vigfusson, Ithaca, NY (US)

Correspondence Address: Weaver Austin Villeneuve & Sampson - Yahoo!, P.O. BOX 70250, OAKLAND, CA, 94612-0250, US

(73) Assignee: Yahoo! Inc., Sunnyvale, CA (US)

(21) Appl. No.: 12/241,765

(22) Filed: Sep. 30, 2008

(51) Int. Cl. G06F 7/06; G06F 17/30

(52) U.S. Cl. 707/759; 707/E17.014; 707/E17.013

(57) ABSTRACT

A method comprises receiving a range query from a requestor. The range query requests a range of sequential items in a database that is distributed among a plurality of storage devices or partitions. The range query is divided into R sub-range queries, where R is an integer. Each sub-range query corresponds to a respective portion of the range of sequential items stored in a respective storage device or partition. The sub-range queries are issued to respective ones of up to K storage servers, where K is an integer less than or equal to R. Each of the K storage servers is configured with read access to the respective storage device or partition storing the respective portion of the range of sequential items in the respective sub-range query issued to that storage server.

### FIELD OF THE INVENTION

The present invention relates to systems and methods for retrieving data using a range query.

### BACKGROUND

In a data store, the range query is a common and frequently executed operation. A dataset or data collection has a plurality of records, each record having a key field, such that the values of the key field may be sequentially arranged. A range query retrieves the records for which the value of the key field is within a range specified by the range query.

For example, an e-commerce table may contain records of items for sale. A record key may be the time at which the item was inserted (concatenated with some unique identifier, such as item id). Another field in each record is a category, such as electronics or housewares. Users pose queries over the database such as “select all items posted in the last 24 hours.” A query may also contain a selection predicate, such as “select all items posted in the last 24 hours where category=car.”

In another example, a table contains record that correspond to web addresses. One non-key field of the records may be “click count,” corresponding to the number of times the page has been visited. There may be an index over the table, where the index key is “click count,” concatenated with the original key. Users pose queries such as “select all pages with click counts greater than 1000.”

In a conventional database, executing a range query is straightforward. Given a set of records sorted by the attribute to be ranged over, the database engine seeks on the disk to the first record falling within the range, and scans sequentially forward through all records in the range. If records are not sorted by the range attribute, a solution is to build an index over the attribute, and scan over the index. Sequential scan is a very efficient way to read records off disk; in the standard single disk setting, it is a very good solution.

Improved range query methods are desired.

### SUMMARY OF THE INVENTION

In some embodiments, a method comprises receiving a range query from a requester, the range query requesting a range of sequential items in a database that is distributed among a plurality of storage devices or partitions. The range query is divided into R sub-range queries, where R is an integer, each sub-range query corresponding to a respective portion of the range of sequential items stored in a respective storage device or partition. The sub-range queries are issued to respective ones of up to K storage servers, where K is an integer less than or equal to R. Each of the K storage servers is configured with read access to the respective storage device or partition storing the respective portion of the range of sequential items in the respective sub-range query issued to that storage server.

In some embodiments, a machine readable storage medium is encoded with computer program code, such that, when the computer program code is executed by a processor, the processor performs the above machine implemented method.

In some embodiments, a method comprises receiving scheduling requests for scheduling resources in response to first and second queries, the first and second queries each requesting a respective range of sequential items in a database that is distributed among a plurality of storage devices or partitions. A respective parameter K is received for each respective query. The parameter K identifies a respective requested number of storage servers to be assigned to retrieve data from the plurality of storage devices or partitions to service the first and second queries, respectively. One of the first and second queries is selected, to which a next available storage server is to be assigned. The selecting being at least partly based on K. An identification of the selected query is transmitted to a range server that retrieves the range of sequential items from the storage servers.

In some embodiments, a machine readable storage medium is encoded with computer program code, such that, when the computer program code is executed by a processor, the processor performs the above machine implemented method.

In some embodiment, a range server comprises a processor configured for receiving a range query from a requestor. The range query requests a range of sequential items in a database that is distributed among a plurality of storage devices or partitions. The processor is configured for dividing the range query into R sub-range queries, where R is an integer, each sub-range query corresponding to a respective portion of the range of sequential items stored in a respective storage device or partition. The processor is configured for issuing the sub-range queries to respective ones of up to K storage servers, where K is an integer less than or equal to R. Each of the K storage servers is configured with read access to the respective storage device or partition storing the respective portion of the range of sequential items in the respective sub-range query issued to that storage server.

In some embodiments, a scheduler comprises a processor configured for receiving scheduling requests for scheduling resources in response to first and second queries, the first and second queries each requesting a respective range of sequential items in a database that is distributed among a plurality of storage devices or partitions. The processor is configured for receiving a respective parameter K for each respective query, the parameter K identifying a respective requested number of storage servers to be assigned to retrieve data from the plurality of storage devices or partitions to service the first and second queries, respectively. The processor is configured for selecting one of the first and second queries to which a next available storage server is to be assigned, the selecting being at least partly based on K. The processor is configured for transmitting an identification of the selected query to a range server that retrieves the range of sequential items from the storage servers.

### BRIEF DESCRIPTION OF THE DRAWINGS

FIG. 1 is a block diagram of one embodiment of a system for performing range queries.

FIG. 2 is a flow chart of a method performed by the range server of FIG. 1.

FIG. 3 is a flow chart of adjustment of the flow control parameter used in FIG. 2.

FIG. 4 is a block diagram of an embodiment of a system for performing a plurality of range queries.

FIG. 5 is a flow chart of a method performed by the range server of FIG. 4.

FIG. 6 is a data flow diagram for the range server and scheduler shown in FIG. 4.

FIG. 7 is a flow chart showing a method performed by the scheduler of FIG. 4.

### DETAILED DESCRIPTION

This description of the exemplary embodiments is intended to be read in connection with the accompanying drawings, which are to be considered part of the entire written description. Terms concerning attachments, coupling and the like, such as “connected” and “interconnected,” refer to a relationship wherein structures are secured or attached to one another either directly or indirectly through intervening I/O and/or communications infrastructure, unless expressly described otherwise.

Overview

In a system having a plurality of storage devices, a dataset or data collection may be divided into a plurality of tables or tablets. The data records within each tablet have a key field, such that the values of the key field may be sequentially arranged. The tablets may be stored in a plurality of storage devices, and a given storage device may contain one or more of the tablets. In the case of a storage device having multiple tablets, the tablets may correspond to continuous ranges of data, or non-contiguous ranges. Systems and methods described herein address the problem of doing range queries over a horizontally partitioned and distributed table. The table is broken into many partitions, with each partition holding a contiguous sub-range of the entire table. The system includes a plurality of storage servers, each of which stores one or more partitions. Although a partition itself contains a contiguous range of records, the different partitions stored in a single storage device or on plural storage devices accessible by a single storage server may be from totally disparate parts of the overall range.

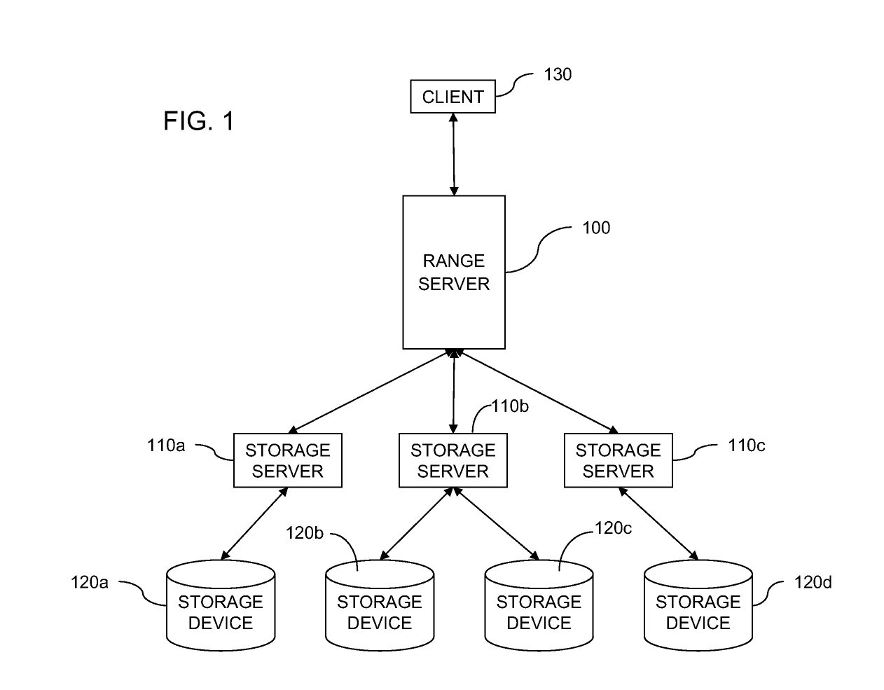

Reference is now made to the system shown in FIG. 1. A range server 100 is adapted to receive and handle range queries from a client 130. The range server 100 is coupled to a plurality of storage servers 110a-110c. The storage servers 110a-110c have access to a plurality of storage devices 120a-120d, each storing at least one tablet of the database. Although an example is shown with three storage servers 110a-110c and four storage devices 120a-120d, the system and method may include any number of storage servers and any number of storage devices.

In one optional method of using this system for processing range queries, the range server 100 handles range queries that enter the system. Range server 100 holds a partition map (not shown), which stores the mapping of each horizontal partition to the storage servers 110a-110c on which it resides. Given a range query from client 130, the range server 100 breaks the query range into sub-ranges along partition boundaries and queries each partition in turn sequentially, while passing results back to the client 130.

The sequential solution described above under-utilizes the potential of the architecture shown in FIG. 1. For a query spanning multiple partitions 120a-120d, if those partitions are accessible by multiple storage servers 110a-110c, partitions can be queried in parallel, and more quickly return results to the client 130. The discussion below is divided into two segments: architecture and flow control.

As mentioned above, a range server 100 handles parallelizing range queries. For a given query, the range server 100 first breaks the range query into sub-ranges along partition boundaries. The following example involves a query for which response includes the end (but not the beginning) of the first partition and the beginning (but not the end) of the second portion. In this example, if the query range is (banana:melon) and partition boundaries are [apple:grape],[grape:pear], the range server 100 breaks the query into (banana:grape) and (grape:melon). Then the range server 100 issues the sub-queries to their respective storage servers 110a-110c. It may choose to issue the queries sequentially, entirely in parallel, or use a combination of sequential and parallel queries. The range server 100 collects results streaming back from the storage servers 110a-110c, and forwards them on the client 130.

Range server 100 uses two rates in measuring range query performance. The first rate is aggregate storage server delivery rate, which is the average number of total bytes/unit of time delivered from all storage servers 110a-110c to the range server 100. The second rate is client uptake rate, the average number of bytes/unit of time the client 130 retrieves from the range server 100. Several factors may affect each of these rates. Aggregate storage server delivery rate is mainly affected by the current level of parallelism (number of servers currently returning results) and query selectivity—a query with a very selective predicate may have servers scanning a large number of records but only returning a few to the range server. Client uptake rate is affected by the speed and/or buffering capacity of the client 130, other tasks being performed by client 130, etc.

Flow control and scheduling influence the degree of parallelism with which a query is processed. In addition, if a client 130 wants results to arrive in a particular order, this may also limit the possible parallelism.

For each query, the range server 100 attempts to match the aggregate storage server delivery rate to the client uptake rate. If the client uptake rate is faster than the delivery rate, the client will often wait for results. If the delivery rate is faster, range server 100 is exploiting parallelism beyond the point at which the client 130 benefits, and perhaps consuming resources better used on behalf of a different client.

The exemplary method and system approximately match the two rates. Range server 100 adjusts a parallelism factor, k, for the client 130, on a query-by-query basis. A client 130 starts with k set to a predetermined initial value for each new query (e.g., k=1). If the client's uptake rate is faster than the delivery rate, a value for k is estimated that would equalize the aggregate server delivery rate and client uptake rate. In some embodiments, k is immediately increased to the estimated value to equalize the rates. In some embodiments, k is increased to an intermediate value, between the initial value and the estimated value. In other embodiments, k is increased by a predetermined increment (e.g., 1).

Generally, increases in k are limited so that so that k does not exceed a number of partitions that can be accessed in parallel by storage servers 110a-110c. This limit may be the number of storage servers. If one or more of the storage servers are capable of accessing plural partitions simultaneously (e.g., a RAID system with multiple read heads), then the limit may be set to the number of partitions that can be accessed in parallel, which would be a greater number than the number of storage servers 110a-110c.

Later, if the client uptake rate becomes slower than the aggregate server delivery rate, k is lowered. In some embodiments, to avoid overreacting to temporary changes in rate, a limit is placed on the size of any single adjustment to k.

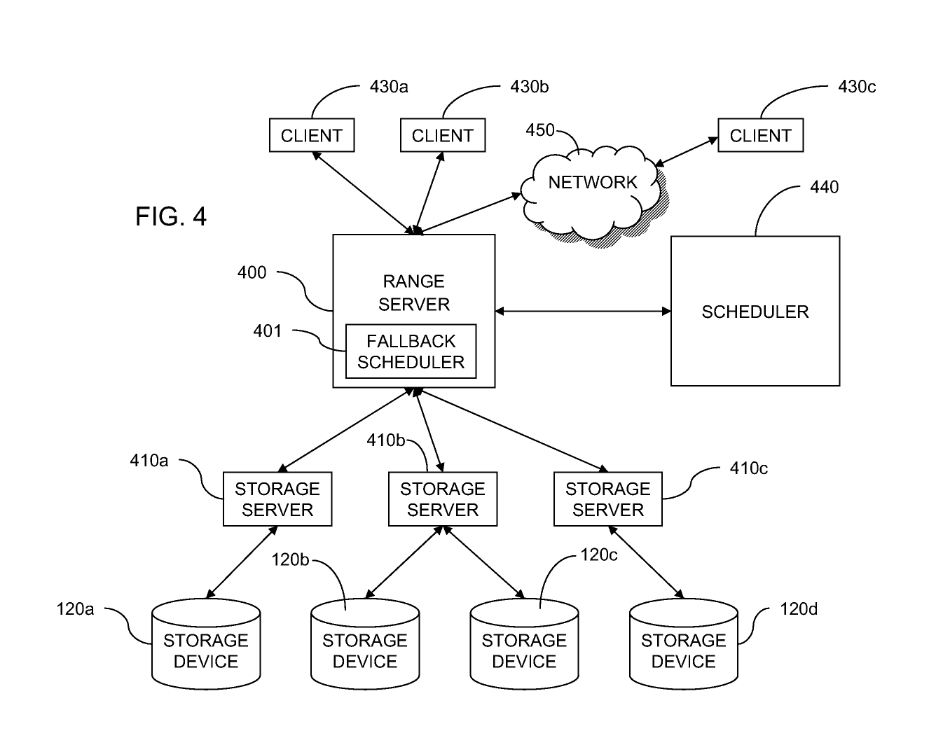

The example of FIG. 1 shows a range server 100 handling one query at a time. As described below in the discussion of FIGS. 4-6, some embodiments can process multiple queries arriving from different clients 430a-430c. These queries contend for the same set of storage servers 410a-410 c, so a scheduler 440 is provided to ensure that the queries are processed in some kind of fair manner. The scheduler receives a few types of information for the range server. First, when a range server 400 receives a query, it submits a request for the appropriate storage servers 410a-410c to the scheduler 440. The scheduler 440 is also provided the respective flow control parameter k associated with each query. When range server 400 completes a particular sub-range query, it notifies the scheduler 440. The scheduler 440 sends information to range server 400, telling them to process a particular sub-range in a particular query next.

Flow Control

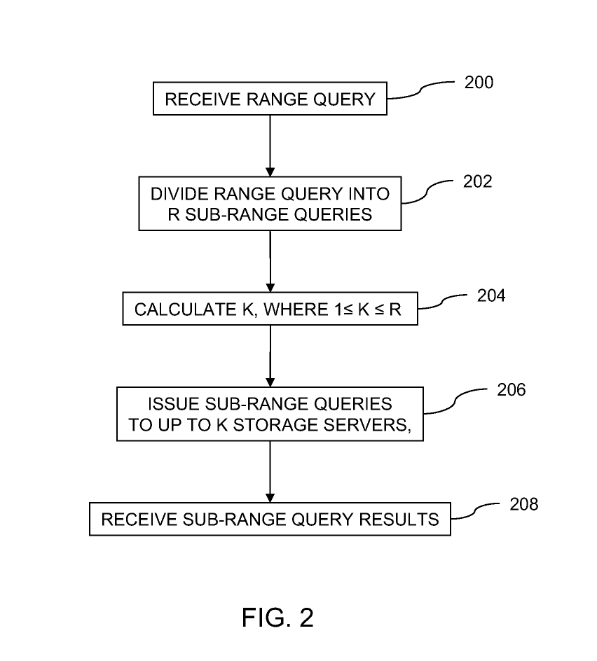

Referring now to FIGS. 1 and 2, a method of handling a query by range server 100 (shown in FIG. 1) is described. This method may be performed in a system that does not include a separate scheduler, and is also an optional failover operating mode for a ranger server in a system having a scheduler (e.g., FIG. 4) in the event of a scheduler outage.

Many factors contribute to the speed at which range queries can be executed. This includes the selectivity of the query, i.e. how many records are filtered by the predicates, the load and speed of the storage servers 110a-110c, tablets sizes, and the like.

In some embodiments, the approach is to address aggregate rate at which storage servers 110a-110c are able to generate and transmit results, not including the time they spend waiting for the range server 100 to pick up results. Aggregate storage server delivery rate refers to the sum of the storage server delivery rates as they are reported by the storage servers 410a-410c. Each storage server 110a-410c keeps track of the number of bytes it has transmitted, and the time taken to transmit those bytes, minus the time spent waiting for the data to be flushed directly to the client 130 a (bypassing internal buffers).

The rate reports from the storage servers 110a-110c are special strings sent after every few records to the range server 100, where they are filtered out, added up and considered in the flow control logic.

In some embodiments, the client rate reporting is absent. In such embodiments, the client library can do a time measurement analogously to that of the storage server 110a, e.g., to measure the time between read calls, excluding the time spent waiting for results. This should be transmitted to the client 130 a at frequent intervals.

The range server 100 includes a loop that polls data that have been buffered from each of storage servers 110a-110c that are being probed, and completed records are transmitted back to the client 130. (In the embodiment shown in FIGS. 4-7, as a part of this loop, range server 400 also checks and handles activity on the scheduler socket.) Finally, at a fixed frequency (e.g., 100 ms) range server 100 runs the flow control algorithm. This is responsible for determining the number of parallel connections range server 100 should try to obtain for this query, given the current number of connections and the upload and download rates by the storage servers 110a-110c and the clients 130.

Referring to FIG. 2, at step 200, range server 100 receives a range query from a requester (e.g., client 130. ) The range query requests a range of sequential items in a database that is distributed among a plurality of storage devices or partitions 120a-120d.

At step 202, range server 100 divides the range query into R sub-range queries, where R is an integer. Each sub-range query corresponds to a respective portion of the range of sequential items stored in a respective storage device or partition 120a-120d.

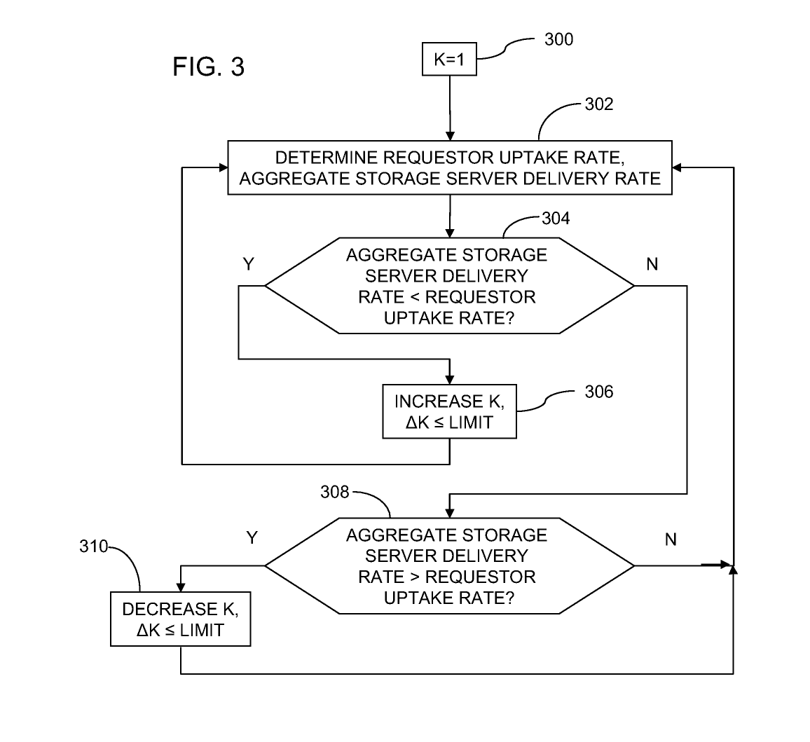

At step 204, range server 100 determines the current value of k. The process of selecting and updating K is described below in the discussion of FIG. 3.

At step 206, range server 100 issues sub-range queries to up to k storage servers 110a-110c where K is an integer less than or equal to R. Each of the K storage servers 110a-110c is configured with read access to the respective storage device or partition storing the respective portion of the range of sequential items in the respective sub-range query issued to that storage server. As noted above, if a given storage server has access to two different devices 120b, 120c with respective tablets that can be read in parallel, then the range server 100 can issue up to k sub-range queries, with fewer than k storage servers 110a-110c.

At step 208, the storage server 100 receives at least one respective portion of the range of sequential items in the sub-range query results from each of the K storage servers and passes them on to the requestor (client 130).

The Flow Control Parameter K

FIG. 3 is a flow chart showing one example of a method for setting the value of k within range server 100.

At step 300, range server 100 initially sets K equal to a predetermined value, such as 1. This initialization is performed before the first request is made to the storage servers to satisfy a given range query.

At step 302, range server 100 determines the aggregate storage server delivery rate. Range server 100 has a storage buffer (not shown) for storing the data of each respective incoming sub range from the storage servers 110a-10c, until receipt of the data from each respective sub range is acknowledged by the client 130. Range server 100 has time stamps indicating when each sub-range query begins and ends transmission from its respective storage server 110a-110c, as well as the size of each sub-range. Thus, range server 100 can easily determine the aggregate storage server delivery rate.

The technique for determining the client uptake rate depends on the protocol between range server 100 and client 130. In some embodiments, range server 100 transmits the range data to client 130 using a connection-oriented protocol, such as TCP, which automatically tracks each sub-range at the message level, indicating when each sub-range is completely received. In other embodiments, a connectionless protocol is used, and client 130 provides an application level acknowledgement of receipt of each entire sub-query. In either case, range server 100 determines the client uptake rate based on the time it takes to empty the sub-range from its buffer.

At step 304, range server 100 determines whether the aggregate storage server delivery rate of the k storage servers is less than the uptake rate of the sequential items by the requestor. If the aggregate storage server delivery rate is less, then step 306 is performed next. If the aggregate storage server delivery rate is greater than or equal to the client uptake rate, step 308 is performed next.

At step 306, range server 100 increases k if the aggregate storage server delivery rate of the k storage servers is less than the uptake rate of the sequential items by the requestor. The increase is limited so as not to exceed a maximum value. In some embodiments, the value of k is doubled. In some embodiments, k is only increased by one storage server at a time. Then the loop is repeated at step 302, with each polling cycle by range server 100.

At step 308, range server 100 determines whether the aggregate storage server delivery rate of the k storage servers is greater than the uptake rate of the sequential items by the requestor. If the aggregate storage server delivery rate is greater, then step 310 is performed next. If the aggregate storage server delivery rate is equal to the client uptake rate, step 302 is performed next.

At step 310, range server 100 decreases k if the aggregate storage server delivery rate of the k storage servers is greater than the uptake rate of the sequential items by the requestor. The decrease is limited to not exceed a maximum value. In some embodiments, the value of k is halved. In some embodiments, k is only decreased by one storage server at a time. Then the loop is repeated at step 302, with each polling cycle by range server 100.

The technique for setting k described with reference to FIG. 3 is only one of the available options. In an alternative embodiment, once the aggregate server delivery rate and client uptake rate are determined for a given query with k=1 (only one server transmitting data), the k is immediately set to the largest integer that is less than or equal to the ratio of the client uptake rate to the server delivery rate of one server. This has the effect of selecting the number of storage servers k, so that an aggregate storage server delivery rate of the k storage servers approximates an available bandwidth of the requester for receiving the sequential items.

Some embodiments set k to exactly or as nearly as possible match the current average storage server download rate to the client uptake rate. If the k storage units range server 100 is currently working on have rates s₁, . . . sₖ bytes/sec, and the client has reported it can handle c bytes/sec, then range server 100 sets the new k to be the following quantity.

$${k}^{′} = \frac{c}{{\sum }_{i = 1}^{k} {s}_{i}} \cdot k . \qquad ( 1 )$$

Equation (1) indicates that if all storage servers 410a-410c have the same rate r, the average of the current storage unit rates, then range server 100 should connect to c/r storage servers 410a-410c.

In some situations, this algorithm provides a high initial estimate for k, and so there should be a cap on how much k can be increased in every round or over some period of time (for instance at most doubled). In some embodiments, this is not done in the flow control logic.

Built into this is a notion of forgetting the past (which could also be done by exponential averaging over time). This is because the average server rate is only based on the rates reported by the storage servers 410a-410c currently being probed, and no historic data is used.

Other embodiments use the technique described above with reference to FIG. 3, which resembles TCP flow control. It may potentially perform better.

Initially the value of k is set to 1. In every round range server 400 evaluates the current aggregate storage server rate

$$s = {\sum }_{i = 1}^{k} {s}_{i}$$

and the client uptake rate c.

If s>c+\sqrt{c}, i.e. the range server 400 is producing output faster than the client 430 a can receive it by more than approximately a standard deviation, then range server 400 halves k, i.e. k←k/2. This is called an exponential back-off.

If s 21 c−\sqrt{c}, then range server 400 doubles k, i.e. k←2k. Subsequently, if range server 400 ever has to back-off, i.e. halve k, then any future increases in k are linear instead of exponential, i.e. k←k+1. This is an exponential initialization, followed by linear increases in k.

Otherwise, if c−\sqrt{c}≦s≦c+\sqrt{c}, then range server 400 leaves k as it is.

The exponent of 2 (by which k is multiplied or divided) can be modified arbitrarily.

FIGS. 4-7 show another embodiment. Reference is now made to the system shown in FIG. 4. A range server 400 is adapted to receive and handle range queries from a plurality of clients 430a-430 c, any of which may be co-located with range server 400 or located remotely and in communication via a network 450, which may be a local area network (LAN), a wide area network (WAN) or the Internet. The range server 400 is coupled to a plurality of storage servers 410a-410 c, and to a scheduler 440, which is described in detail below. The storage servers 410a-410c have access to a plurality of storage devices 420a-420d, each storing at least one tablet of the database. Although an example is shown with three storage servers 410a-410c and four storage devices 420a-420d, the system and method may include any number of storage servers and any number of storage devices.

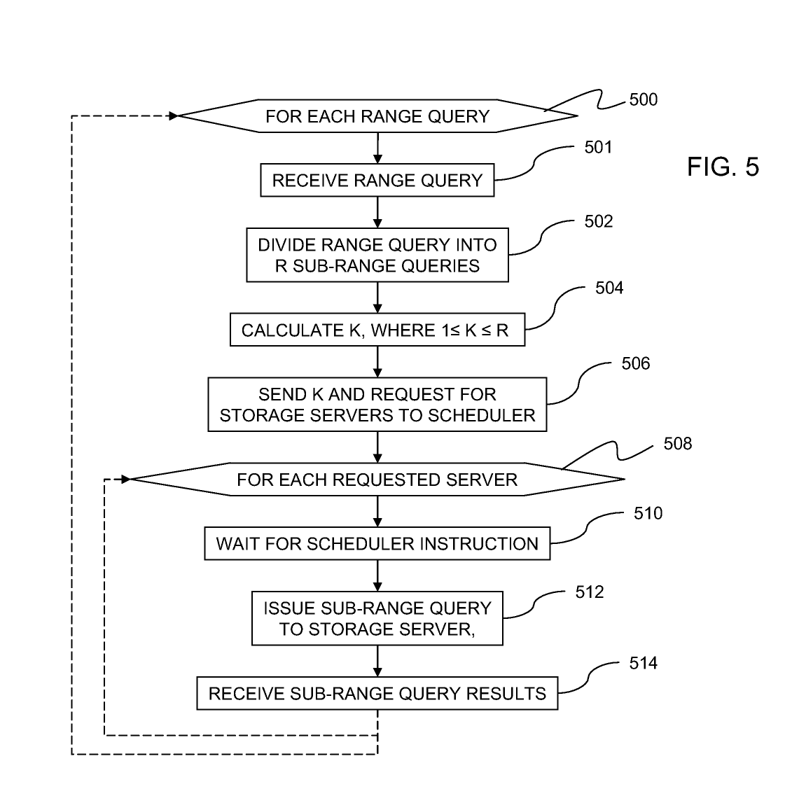

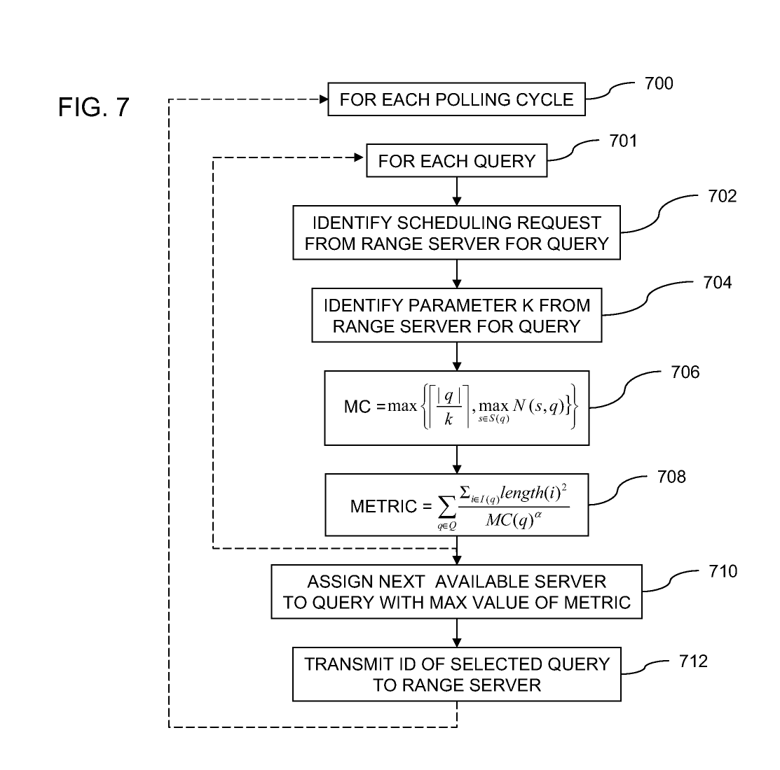

The operation of the range server 400 is similar to that described above with reference to FIG. 2, with the addition of coordination with scheduler 440. Referring to FIG. 5, operation of the range server 400 is summarized. A more detailed example follows the discussion of FIG. 7.

At step 500, a loop including steps 501 -514 is performed for each range query. One of ordinary skill will understand that the various instantiations of the loop of steps 501-514 can execute concurrently. Range server 400 does not wait for completion of the first range query to begin processing the second range query.

At step 501, range server 400 receives a range query from a requester (e.g., client 430a.) The range query requests a range of sequential items in a database that is distributed among a plurality of storage devices or partitions 420a-420d.

At step 502, range server 400 divides the range query into R sub-range queries, where R is an integer. Each sub-range query corresponds to a respective portion of the range of sequential items stored in a respective storage device or partition 420a-420d.

At step 504, range server 400 determines the current value of k for the query. The process of selecting and updating k is described above in the discussion of FIG. 3.

At step 506, range server 400 sends the value k and a request for the desired storage servers (i.e., those having access to the tablets that satisfy the range query).

At step 508, a loop including steps 510 -514 is performed for each requested storage server. One of ordinary skill will understand that any or all of the various instantiations of the loop for steps 510 -514 can be performed concurrently.

At step 510, range server 400 waits until it receives an instruction from scheduler 440 to request a tablet from the storage server having access to one of the tablets.

At step 512, range server 100 issues the sub-range queries to the particular storage server 110a-10c corresponding to the instruction from scheduler 440.

At step 514, the storage server 100 receives at least one respective portion of the range of sequential items in the sub-range query results from the storage servers associated with the instruction from scheduler 440 and passes them on to the requester (client 130).

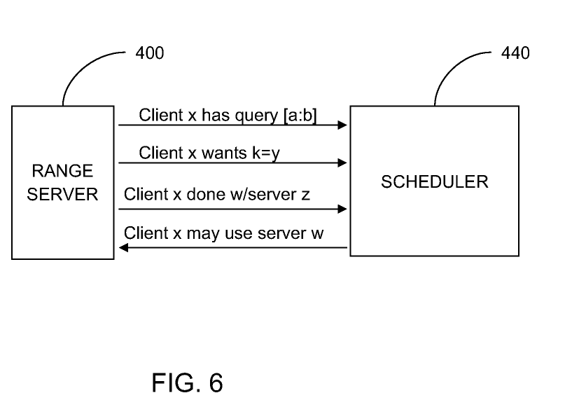

FIG. 6 is a data flow diagram of the messages exchanged between an exemplary range server 400 and an exemplary scheduler 440.

The first message indicates that client x has a query [a:b]. In some embodiments, this request includes a list of the specific servers that have access to the sub-ranges of the query [a:b].

The second message indicates the value of k, indicating the number y of storage servers 410a-410c that range server 400 is currently requesting for the query [a:b]. The second message is kept separate from the definition of the range of query [a:b], so that range server 400 can update its number of requested storage servers for the same query.

The third message is sent to the scheduler when one of the sub-ranges completes transmission. In general, if two distinct, non-consecutive partitions (e.g., 420b, 420c) are accessed by the same storage server (e.g., 410b), then range server 400 sends the third message at the completion of each sub-range, relinquishing the storage server 410b after receiving the first sub-range, and waiting for another instruction from the scheduler before requesting the next sub-range 420c from the same storage server 410b.

The fourth message is sent by scheduler 440, instructing range server 400 when a given client is permitted to access one of the requested storage servers.

Scheduler

One or more schedulers 440 are provided. Some embodiments include plural schedulers 440; which may use a gossip protocol so each scheduler 440 can maintain a complete list of all ongoing queries.

The scheduler service 440 is responsible for performing multi-query optimization in the system by minimizing contention on storage servers 410a-410c and balancing load. The scheduler 440 is notified by the range server 400 regarding what storage servers 410a-410c need to be used by the queries, and how often. Scheduler 440 then determines which query should use which storage servers 410a-410c and when.

The scheduler 440 executes a scheduling algorithm based on fairness. Consider a workload consisting of many short jobs which are interactive and expect to get results fast, and long jobs which can linger in the background, but should ideally get some initial results fast. It is preferable that the scheduling algorithm does not starve jobs, or impose too long idle periods on the queries in the sense that should make steady (rather than bursty) progress.

The scheduler 440 determines when to notify range server 400 that a given query may process a sub-range, and scheduler 440 determines which server can be assigned to the given query next.

Preferably, the scheduler 440 does not schedule multiple sub-ranges on the same storage server 410a-410c at the same time. If multiple sub-range queries are scheduled in parallel on the same storage server 410a-410 c, the two queries would contend for disk, providing worse throughput than if they were done one-at-a-time (an exception is the case in which two queries require very similar sub-ranges).

Preferably, the scheduler 440 does not schedule a sub-range for a query such that it pushes the number of storage servers concurrently assigned to that query over the flow control k value.

Two different examples of algorithms are described herein, but other algorithms may alternatively be used. A round is a single execution of the flow control logic, which happens at fixed time intervals.

In some embodiments, a FIFO (first in, first out) scheduler prioritizes queries based on order of arrival. This means that given a free storage server 410a-410c, the scheduler 440 finds the earliest query that (a) has a sub-range accessible by that storage server and (b) is currently assigned a number of storage servers smaller than the respective k value for that query.

In other embodiments, the scheduler 440 uses a scheduling metric, called size-weighted round robin (summarized above in steps 706 and 708 of FIG. 7). This metric is designed to be fair in terms of giving each query a steady flow of results, but with the added ability to prioritize short queries over long queries (or even vice-versa). The inventors have determined that short jobs often correspond to end user requests that must see results quickly, while longer jobs more often can be done in the background (i.e. no one is immediately looking at the results). The size-weighted round robin scheduling metric can be used to control the amount of favoritism given to short jobs. By adjusting a parameter α, the user can configure the scheduler 440 to prefer a new short query to an existing long query that has not been granted a storage server 410a-410c for a long time, or the scheduler 440 can be configured to use length as a tiebreaker between two queries that have been waiting for equal amounts of time.

FIG. 7 is a flow chart summarizing an example of a method performed by the scheduler 440. A more detailed example follows the discussion of FIG. 7.

At step 700, a loop including steps 701-708 is performed for each polling cycle.

At step 701, a loop including steps 702-708 is performed for each query.

At step 702, the scheduler 440 identifies the pending queries and storage server requests received from the range server 400 for each query.

At step 704, the scheduler identifies the current value of k for the query received from the range server 400, indicating the number of storage servers requested in parallel.

At step 706, the storage scheduler 440 computes a minimum completion time MC for the query, which is the ideal amount of time in which the entire range query can be completed if the query is assigned all k of the storage servers requested, taking into account whether any of the storage servers 110a-110d is requested multiple times for distinct, non-contiguous tables.

Let MC refer to the minimum completion time for query q. This is not simply the length of the query, since each query has an associated value of k (that may vary but is assumed fixed at the current value of k for the calculation), and may be desiring some servers more than others.

The minimum completion time MC(q) for query q equals

$$M C ( q ) = max \{ ⌈ \frac{\vert q \vert}{k} ⌉ , {max}_{s ∈ S ( q )} N ( s , q ) \} \} \qquad ( 3 )$$

where S(q) is the set of storage servers 410a-410c used by query q, and N(s, q) is the number of times server s is used by query q.

At step 708, a metric is calculated. The metric has a numerator that increases with the sum of the squares of the delay times already encountered by this query. The denominator increases with the minimum completion time calculated in step 706, raised to the a power, where a is a selectable parameter that controls the preference for assigning storage servers to longer queries versus shorter queries.

Let Q be the set of queries, and I(q) denote the set of idle times for the query qεQ. For instance, suppose query A was delayed by 1 sec, and then later by 2 seconds, and query B was delayed by 1 sec at three different times. In some embodiments, query A receives higher priority than query B, since it did not have the same kind of steady progress. The scheduler can encourage Round-Robin like behavior with a tunable preference for long jobs versus short. One example of a metric that provides this capability is the following.

$$metric = {\sum }_{q ∈ Q} \frac{{\sum }_{i ∈ I ( q )} {length ( i )}^{2}}{M {C ( q )}^{α}} \qquad ( 2 )$$

Alternative—Most Starved First

Some embodiments optimize the metric attempts to first please those queries that are currently idling, because the penalty increases quadratically in the idle period. In more detail, this variation sorts queries by the potential penalty they would contribute with respect to the optimization metric, and tries to first serve the queries subjected to the longest idling.

Assume that query q has currently been idling for iq time units, and that its computed minimum completion time is MC(q) for a fixed k.

Sort queries into a queue of decreasing order by

$$\frac{{i}_{q}^{2}}{M {C ( q )}^{α}} .$$

While the queue is not empty, pop query q from the front and do as follows.

If some job in q can be scheduled now, do so, otherwise continue looping.

If the current level of parallelism is less than k_{q}, add q to the back of the queue.

This is a specific instance of a more general greedy algorithm to try to allocate all available resources as soon as they are freed.

In each polling loop, the scheduler 440 repeats steps 706 and 708, to re-compute the minimum completion time MC and metric for each of the currently pending range queries.

At step 710, scheduler 440 assigns the next available storage server 410a-410c to the query having the maximum value of the metric calculated at step 710.

At step 712, scheduler 440 transmits the identification of the next storage server assignment to the range server 400, including identification of the storage server and the client (query) to which the storage server is assigned.

The scheduler 440 can be extended further to make use of cache and locality of queries. For instance, if multiple queries need results from the very same tablet, they should ideally be merged to optimize the performance of the system. Similarly, if it is known that some queries have recently been made to a particular tablet, it is likely that the pages are still being cached. In some embodiments, scheduler takes this into account and directs range server 400 to consult that storage server 410a before others. In such embodiments, the system keeps track of more state information, such as load of storage servers 410a-410c, tablets recently visited, and the like, in order to be able to perform optimization based on these variables.

In some embodiments (particularly in those concurrently servicing multiple queries having both large and small query sizes), the range server 400 may return the sub-ranges in an arbitrary order, in which case the client 430a is responsible for ordering the sub-ranges. Implementing the following alternative approach would allow clients who wish to receive the results in order, at possible performance cost.

Since data from within each tablet arrive in order, if range server 400 visits the tablets approximately in order the results are returned in order.

Firstly, range server 400 may need to buffer up data in the client library. Ideally, the buffer of range server 400 does not fill up quicker than the client 430 a can retrieve data, so the flow control mechanism can be adapted so that the client library download rate to range server 400 is proportional to how fast the client is absorbing data in the sorted order.

Secondly, the order in which storage servers 410a-410c are visited should be biased towards being as close to the sorted order as possible.

Thirdly, when range server 400 receives results from multiple storage servers 410a-410c (for larger k), it becomes possible to put them in buckets according to what part of the range they cover (according to the Client Range List). If range server 400 retrieves a result that is in the front of the Range List, i.e. the smallest key that range server 400 hasn't visited yet, then that can be returned to the user by the client library. Otherwise, range server 400 buffers the result.

The scheduler 440 can make use of the hint that it receives about the query having to traverse tablets in order. When considering a future schedule, it in fact knows what servers need to be visited by the sorted query, and so the sorted query can be considered equivalent to a query that only needs to access one particular storage server 410a and give that query a preference over another query that can use any available storage server.

Fallback scheduler

Reference is again made to FIG. 4. Should the scheduler stop functioning, some embodiments of range server 400 are able to recover by falling back to its own internal fallback scheduler 401.

One way to alleviate this problem is to reduce k to a small number, and fall back to a built-in fallback scheduler 401 that attempts to schedule storage servers 410a-410c at random. If the scheduler 440 comes back up, range server 400 should reveal the current state of the query and allow scheduler 440 to again take over. Fallback scheduler 401 then remains dormant until scheduler 440 again becomes unavailable.

Another alternative is to have the scheduler 440 plan ahead of time the order of which the storage servers 410a-410c should be visited during a scheduler outage, and provide this information to the range server 400. This way the fall-back scheduler 401 would have a good “evacuation route” in case the scheduler 440 goes down, since this route is guaranteed to respect the schedules of other queries. The scheduler 440 still reserves the right to change the schedule at any given point, and in fact remains the primary source for notifying the range server 400 regarding what storage servers 410a-410c they should be visiting.

Scalability

Each range server can run a number of range server processes, but there is a single local scheduler responsible for planning the query destinations for each of these processes. As things scale up, there will be multiple range servers, and it may not be scalable or feasible for all of them to communicate to the same scheduler.

When there are multiple schedulers, it would be highly beneficial if they could notify one another about the plans that they are making for the same storage servers. A simple way to do this that each scheduler connects to all other schedulers, and that they send notifications about the queries they are planning. The frequency at which they send queries determines the quality of the schedules, but includes a natural performance trade-off. It is not particularly important that all schedulers know about the desires of short queries, but longer running queries, which touch more servers and tablets, could easily become a performance bottleneck if schedulers are oblivious to their effects.

One way of minimizing communication overhead would be to use a gossip protocol, and send gossip messages only about “long” queries, which is deliberately left vague. In an exchange gossip protocol nodes pick a neighbor at random at some frequency, connect to that neighbor and compare the knowledge of current queries with that neighbor. If that neighbor has not heard about the long query running on server 110c, range server 100 tells that neighbor about it, and instead gets information about two long queries running on server 9, and one on server 6. The biggest benefit of gossip is the fixed bandwidth consumption, which offers scalability in the setting at which the Sherpa platform is deployed, at the cost of slower data dissemination rates.

In some alternative embodiments, the model for the scheduling algorithms is extended to include weights on the tablets, where a weight is simply a scalar denoting how large the tablet is relative to the maximum tablet size. For instance, the time taken to run a query (with k=1) is proportional to the sum of the weights of the tablets it needs to touch.

The exemplary architectures described herein exploit the parallelism in the system to answer range queries faster than if done sequentially. The flow control in range server 400 tunes the degree of parallelism with which a query is processed, based on the ability of the client 430a-430c to receive the results. The scheduler 440 ensures that multiple queries do not contend for the same storage server 410a-410c simultaneously, and enacts policies to control the relative priorities of the different queries.

Detailed Example.

Assume a client 430a wishes to search an ordered table to find the results from the range 1500-4200 that match a predicate P.

The client 430a issues this query which is directed to range server 400. The range server 400, a router that is equipped to handle range queries, now proceeds to determine what storage servers 410a-410c contain the range of data requested by the query. Range server 400 looks up 1500 in its interval map, determines that the tablet boundaries of the value 1500 are 1001-2000, and finds higher ranges until it finds 4200. Assume the tablets are as follows.

TABLE 1

| Tablet Range | Device | Server |
|---|---|---|
| 1001-2000 | 120a | server 110a |
| 2001-3000 | 120b | server 110b |
| 3001-4000 | 120c | server 110b |
| 4001-5000 | 120d | server 110c |

The range server 400 now populates a list of the ranges it is to try, separated by tablet boundaries. In this case, the list L would be 1200-2000, 2001-3000, 3001-4000, 4001-4200. This is done by consulting an Interval Map (IMAP) that is generated by a router process running on the range server 400.

The next step is to send the results off to the storage servers 410a-410c to retrieve the data from the storage device units 420a-420d. There are two determinations to be made:

(a) How many storage servers 410a-410c should be asked to retrieve data in parallel?

(b) In what order should the storage servers 410a-410c be visited?

The range server 400 addresses the first question by means of the flow control mechanism, which attempts to match the rate at which the servers generate results (depending among other things on the selectivity of the query) to the rate at which the client can process results.

The answer to the second question is straightforward in the case of FIGS. 1 and 2, where only a single query is being serviced by the range server 100. If the range server 100 is only servicing a single query from one client 130, as shown in FIG. 1, then the storage servers 110a-110c are visited according to the order of the tablets to be returned. In the example of Table 1 above, the tablets with data in the ranges 1500-2000, 2001-3000, 3001-4000 and 4001-4200 are stored in respective storage devices 120a, 120b, 120 c, and 120d, which are accessible by storage servers 110a, 110b, 110b and 110c, respectively. Therefore, the range server 100 requests data from the storage servers 110a, 110b and 110c in that order. In the example of only a single query, the range server 100 may issue two requests to storage server 110b for the data in 2001-3000 and 3001-4000, respectively, or the range server 100 may issue a single query for the range 2001-4000. Because there is no contention with any other query, the result is essentially the same.

However, if the range server 400 is being queried by multiple clients (as discussed above with reference to FIGS. 4-7) the second question is addressed by consulting the scheduler 440 whose purpose is to optimize accesses of storage servers 410a-410c by multiple queries with respect to performance. Although the scheduler 440 is shown in FIG. 4 as being a separate processor from the range server 400, in alternative embodiments, the scheduler 440 and range server 400 may be hosted in the same computer.

Referring again to FIG. 4, the range server 400 notifies the scheduler 440 via socket that it has received a query that touches servers 410a, 410b and 410c, and server 410b twice. The range server now enters a processing loop. This loops polls a scheduler socket along with all other sockets to storage servers 410a-410c for data. A response to the scheduling notification tells the range server 400 to connect to server 410a. This causes the range server 400 to connect to server 410a via an interface that is polled in the loop.

A query arrives at the storage server 410a requesting the range 1200:2000. The storage unit 410a recognizes that the special character means that the range query code should be used. It asks the data store (which may be, for example, a B-tree or a database management system, DBMS, e.g., “MYSQL” from MySQL AB of Sweden) about the results, installs a callback handler and then exits. The callback handler is responsible for retrieving results from the DBMS one at a time, and immediately flush them to the range server 400. The storage server 410a also reports how fast it is sending results (e.g., as number of bytes/millisecond), either explicitly, or inherently through the communications protocol between range server 400 and storage server 410a.

Meanwhile, the range server 400, as a part of an ongoing polling loop, tries to match the reception rate by client 430 a and the aggregate server transmission rate. A flow control module of the range server 400 performs this function.

The flow control module start by allowing k=1 servers to be probed in parallel. In some embodiments, the range server 100 implements flow control by dynamically modifying the number of concurrent requests k, and so it increases or decreases the value of k according to the average server rates that have been reported by the storage servers 410a-410c and the reported client download rate. When k changes, the range server 400 notifies the scheduler 440 so the scheduler 440 can notify range server 400 to connect to new storage servers 410a-410c. In some embodiments, when k is decreased, range server 400 does not disconnect from the storage servers 410a-410c that are servicing the query. Rather, range server 400 relies on the fact that if the client 430 a is too slow at receiving messages, the blocking writes and flushes are going to allow the storage server 410a and the range server 400 to sleep while waiting for data to be picked up by the client 430a, and so the corresponding machines can switch context to other processes or queries. In other embodiments, to avoid any reduction in performance due to the storage server 410a sleeping when a client 430 a is slow, the scheduler 440 learns when the storage server 410a is not currently scanning any tablets. Then the storage server 440 can schedule another query on that storage server 410a.

When the range server 400 receives data from a storage server 410a-410c, a write-back handler (not shown) will check if there is an entire record to be found in the current data buffer, and if so, flush it to the client 430a. This causes the records to arrive in an arbitrary order back at the client side, in a first-in first-out (FIFO) basis. The complete set of records arrives as a large JavaScript Object Notation (JSON) object at the client 430a, and an incremental JSON parser in the client library is responsible for detecting when a new record is available rather than waiting for the whole structure to buffer up.

When a result is received from the storage server 410a, range server 400 ticks off the list of ranges corresponding to the sub-ranges that are known to have been scanned. Assume the first record from server 410 a had primary key 1216. Range server 400 knows that all keys between and including 1200 and 1216 have been scanned. Consequently, range server 400 modifies its list of remaining ranges L to be 1216-2000, 2000-3000, 3000-4000, 4000-4200. This means that, if the storage server 410a fails during transmission, range server 400 can resend the request to a different storage server 410b or 410c (possibly located in a different region) containing the 1000-2000 tablet from table, and range server 400 knows exactly where to pick up without having to notify the client 430a of the failure.

When a request is finalized from storage server 410a, range server 400 ticks off all of the remaining ranges that that storage server 410a was working on. In this case, upon receiving record 1992 and then having server 410a disconnect, range server 400 knows that all of sub-range 1200-2000 has been scanned, but range server 400 is careful not to tick off any other ranges belonging to that server.

The present invention may be embodied in the form of computer-implemented processes and apparatus for practicing those processes. The present invention may also be embodied in the form of computer program code embodied in tangible machine readable storage media, such as random access memory (RAM), floppy diskettes, read only memories (ROMs), CD-ROMs, hard disk drives, flash memories, or any other machine-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, such that, when the computer program code is loaded into and executed by a computer, the computer becomes an apparatus for practicing the invention. When implemented on a general-purpose processor, the computer program code segments configure the processor to create specific logic circuits. The invention may alternatively be embodied in a digital signal processor formed of application specific integrated circuits for performing a method according to the principles of the invention.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method comprising:
receiving a range query from a requester, the range query requesting a range of sequential items in a database that is distributed among a plurality of storage devices or partitions;
dividing the range query into R sub-range queries, where R is an integer, each sub-range query corresponding to a respective portion of the range of sequential items stored in a respective storage device or partition;
issuing the sub-range queries to respective ones of up to K storage servers, where K is an integer less than or equal to R, each of the K storage servers being configured with read access to the respective storage device or partition storing the respective portion of the range of sequential items in the respective sub-range query issued to that storage server.

2. The method of claim 1, further comprising:
initially setting K equal to a predetermined value;
increasing K if an aggregate storage server delivery rate of the K storage servers is less than an uptake rate of the sequential items by the requester.

3. The method of claim 2, further comprising reducing K if the aggregate storage server delivery rate of the K storage servers is greater than the uptake rate of the sequential items by the requester.

4. The method of claim 3, further comprising limiting an amount by which K is increased or decreased in a given period of time.

5. The method of claim 2, further comprising:
transmitting a request for use of a given number of storage servers and an identification of the value K to a scheduler; and
receiving access to the storage servers by way of up to K storage servers from the scheduler.

6. The method of claim 1, further comprising:
selecting the number K of storage servers, so that an aggregate storage server delivery rate of the K storage servers approximates an available bandwidth of the requester for receiving the sequential items.

7. The method of claim 1, further comprising:
receiving at least one respective portion of the range of sequential items from each of the K storage servers; and
forwarding the range of sequential items to the requester.

8. The method of claim 1, further comprising
receiving a second range query from a second requester;
dividing the second range query into S sub-range queries, where S is an integer;
issuing the S sub-range queries to respective ones of L storage servers, where L is an integer less than or equal to S, such that individual sub-range queries of the first range query and individual sub-range queries of the second range query are issued to the storage servers in round robin fashion or in first-in, first-out fashion.

9. A method comprising:
receiving scheduling requests for scheduling resources in response to first and second queries, the first and second queries each requesting a respective range of sequential items in a database that is distributed among a plurality of storage devices or partitions;
receiving a respective parameter K for each respective query, the parameter K identifying a respective requested number of storage servers to be assigned to retrieve data from the plurality of storage devices or partitions to service the first and second queries, respectively,
selecting one of the first and second queries to which a next available storage server is to be assigned, the selecting being at least partly based on K; and
transmitting an identification of the selected query to a range server that retrieves the range of sequential items from the storage servers.

10. The method of claim 9, wherein the selecting is partly based on a selectable value of a parameter that determines one of the group consisting of a degree of preference for queries having a response size below a predetermined threshold and a degree of preference for relatively short queries over relatively long queries.

11. The method of claim 9, wherein the selecting step includes selecting the one of the first and second queries for which a respective metric has a higher value, and the metric associated with each query increases with idle time during response to the query.

12. The method of claim 9, wherein the selecting step includes selecting the one of the first and second queries for which a respective metric has a higher value, and the metric is calculated by a ratio having a denominator that varies with a minimum potential time for responding to the query.

13. The method of claim 9, wherein:
the selecting step includes selecting the one of the first and second queries for which a respective metric has a higher value,
the metric associated with each query is calculated by a ratio that increases with idle time during response to the respective query; and
the ratio has a denominator that varies with a minimum potential time for responding to the respective query.

14. The method of claim 9, wherein the parameter K and the scheduling requests are received from the range server, and the range server has access to the plurality of storage servers.

15. A machine readable storage medium encoded with computer program code, wherein when the computer program code is executed by a processor, the processor performs a machine implemented method comprising the steps of:
receiving a range query from a requestor, the range query requesting a range of sequential items in a database that is distributed among a plurality of storage devices or partitions;
dividing the range query into R sub-range queries, where R is an integer, each sub-range query corresponding to a respective portion of the range of sequential items stored in a respective storage device or partition;
issuing the sub-range queries to respective ones of up to K storage servers, where K is an integer less than or equal to R, each of the K storage servers being configured with read access to the respective storage device or partition storing the respective portion of the range of sequential items in the respective sub-range query issued to that storage server.

16. The machine readable storage medium of claim 15, wherein the method further comprises:
initially setting K equal to a predetermined value;
increasing K if an aggregate storage server delivery rate of the K storage servers is less than an uptake rate of the sequential items by the requester.

17. The The machine readable storage medium of claim 16, further comprising reducing K if the aggregate storage server delivery rate of the K storage servers is greater than the uptake rate of the sequential items by the requester.

18. The machine readable storage medium of claim 15, wherein the method further comprises:
transmitting a request for use of a given number of storage servers and an identification of the value K to a scheduler; and
receiving access to the storage servers by way of up to K storage servers from the scheduler.

19. The machine readable storage medium of claim 15, wherein the method further comprises:
selecting the number K of storage servers, so that an aggregate storage server delivery rate of the K storage servers approximates an available bandwidth of the requester for receiving the sequential items.

20. The machine readable storage medium of claim 15, wherein the method further comprises:
receiving a second range query from a second requester;
dividing the second range query into S sub-range queries, where S is an integer;
issuing the S sub-range queries to respective ones of L storage servers, where L is an integer less than or equal to S, such that individual sub-range queries of the first range query and individual sub-range queries of the second range query are issued to the storage servers in round robin fashion or in first-in, first-out fashion.

21. A machine readable storage medium encoded with computer program code, wherein when the computer program code is executed by a processor, the processor performs a machine implemented method comprising the steps of:
receiving scheduling requests for scheduling resources in response to first and second queries, the first and second queries each requesting a respective range of sequential items in a database that is distributed among a plurality of storage devices or partitions;
receiving a respective parameter K for each respective query, the parameter K identifying a respective requested number of storage servers to be assigned to retrieve data from the plurality of storage devices or partitions to service the first and second queries, respectively, selecting one of the first and second queries to which a next available storage server is to be assigned, the selecting being at least partly based on K; and
transmitting an identification of the selected query to a range server that retrieves the range of sequential items from the storage servers.

22. The machine readable storage medium of claim 21, wherein the selecting is partly based on a selectable value of a parameter that determines one of the group consisting of a degree of preference for queries having a response size below a predetermined threshold and a degree of preference for relatively short queries over relatively long queries.

23. The machine readable storage medium of claim 21, wherein the selecting step includes selecting the one of the first and second queries for which a respective metric has a higher value, and the metric associated with each query increases with idle time during response to the query.

24. The machine readable storage medium of claim 21, wherein the selecting step includes selecting the one of the first and second queries for which a respective metric has a higher value, and the metric is calculated by a ratio having a denominator that varies with a minimum potential time for responding to the query.

25. The machine readable storage medium of claim 21, wherein:
the selecting step includes selecting the one of the first and second queries for which a respective metric has a higher value,
the metric associated with each query is calculated by a ratio that increases with idle time during response to the respective query; and
the ratio has a denominator that varies with a minimum potential time for responding to the respective query.

26. The machine readable storage medium of claim 21, wherein the parameter K and the scheduling requests are received from the range server, and the range server has access to the plurality of storage servers.

27. A range server, comprising:
a processor configured for receiving a range query from a requester, the range query requesting a range of sequential items in a database that is distributed among a plurality of storage devices or partitions;
said processor configured for dividing the range query into R sub-range queries, where R is an integer, each sub-range query corresponding to a respective portion of the range of sequential items stored in a respective storage device or partition;
said processor configured for issuing the sub-range queries to respective ones of up to K storage servers, where K is an integer less than or equal to R, each of the K storage servers being configured with read access to the respective storage device or partition storing the respective portion of the range of sequential items in the respective sub-range query issued to that storage server.

28. The range server of claim 27, wherein the processor is configured for:
initially setting K equal to a predetermined value; and
increasing K if an aggregate storage server delivery rate of the K storage servers is less than an uptake rate of the sequential items by the requester.

29. The range server of claim 28, wherein the processor is configured for reducing K if the aggregate storage server delivery rate of the K storage servers is greater than the uptake rate of the sequential items by the requester.

30. The range server of claim 28, wherein the processor is configured for:
transmitting a request for use of a given number of storage servers and an identification of the value K to a scheduler; and
receiving access to the storage servers by way of up to K storage servers from the scheduler.

31. The range server of claim 28, wherein the processor is configured for:
selecting the number K of storage servers, so that an aggregate storage server delivery rate of the K storage servers approximates an available bandwidth of the requester for receiving the sequential items.

32. The range server of claim 28, wherein the processor is configured for:
receiving at least one respective portion of the range of sequential items from each of the K storage servers; and
forwarding the range of sequential items to the requester.

33. The range server of claim 28, wherein the processor is configured for receiving a second range query from a second requester;
dividing the second range query into S sub-range queries, where S is an integer;
issuing the S sub-range queries to respective ones of L storage servers, where L is an integer less than or equal to S, such that individual sub-range queries of the first range query and individual sub-range queries of the second range query are issued to the storage servers in round robin fashion or in first-in, first-out fashion.

34. A scheduler comprising:
a processor configured for receiving scheduling requests for scheduling resources in response to first and second queries, the first and second queries each requesting a respective range of sequential items in a database that is distributed among a plurality of storage devices or partitions;
said processor configured for receiving a respective parameter K for each respective query, the parameter K identifying a respective requested number of storage servers to be assigned to retrieve data from the plurality of storage devices or partitions to service the first and second queries, respectively,
said processor configured for selecting one of the first and second queries to which a next available storage server is to be assigned, the selecting being at least partly based on K; and
said processor configured for transmitting an identification of the selected query to a range server that retrieves the range of sequential items from the storage servers.

35. The scheduler of claim 34, wherein the selecting is partly based on a selectable value of a parameter that determines one of the group consisting of a degree of preference for queries having a response size below a predetermined threshold and a degree of preference for relatively short queries over relatively long queries.

36. The scheduler of claim 34, wherein the selecting step includes selecting the one of the first and second queries for which a respective metric has a higher value, and the metric associated with each query increases with idle time during response to the query.

37. The scheduler of claim 34, wherein the selecting step includes selecting the one of the first and second queries for which a respective metric has a higher value, and the metric is calculated by a ratio having a denominator that varies with a minimum potential time for responding to the query.

38. The scheduler of claim 34, wherein:
the selecting step includes selecting the one of the first and second queries for which a respective metric has a higher value,
the metric associated with each query is calculated by a ratio that increases with idle time during response to the respective query; and
the ratio has a denominator that varies with a minimum potential time for responding to the respective query.

39. The scheduler of claim 34, wherein the parameter K and the scheduling requests are received from the range server, and the range server has access to the plurality of storage servers.
